(19) United States
(12) Patent Application Publication
(10) Pub. No.: US 2013/0030553 A1
(43) Pub. Date: Jan. 31, 2013

(54) METHOD OF CONTROLLING NETWORK SYSTEM

(71) Applicants: Koonseok Lee, Geumcheon-gu (KR); Hoonbong Lee, Geumcheon-gu (KR); Yanghwan Kim, Geumcheon-gu (KR)

(72) Inventors: Koonseok Lee, Geumcheon-gu (KR); Hoonbong Lee, Geumcheon-gu (KR); Yanghwan Kim, Geumcheon-gu (KR)

(21) Appl. No.: 13/516,522

(22) PCT Filed: Nov. 26, 2010
(86) PCT No.: PCT/KR2010/008430

§ 371 Date: Jun. 15, 2012

(30) Foreign Application Priority Data
Dec. 17, 2009 (KR) 1020090126360

(51) Int. Cl. G05B 11/01

(52) U.S. Cl. 700/22

(57) ABSTRACT

Provided is a method of controlling a network system. In the method, it is determined whether a communication modem of an electric product is operable by transmitting a signal between the communication modem and a component. If the communication modem is operable for communication with the component, an operation of the electric product is controlled based on power information received through the communication modem.

### TECHNICAL FIELD

The present disclosure relates to a method of controlling a network system.

### BACKGROUND ART

Electric products operate while consuming electric energy. Since electric products consume electric energy, the amount of electricity consumption or electricity charge may be a sensitive matter to users.

As energy consumption increases, it is necessary to develop more energy sources and produce more electric energy. However, electricity generation causes a large amount of greenhouse gas and environmental problems such as global warming. To reduce emission of greenhouse gas, particularly, carbon dioxide, alternative energy sources have been developed such as wind power, solar light, solar heat, geothermal power, tidal power, and water power as well as nuclear power and fuel cells.

Along with this, a smart grid has been proposed as the next generation power grid to improve energy efficiency by realizing two-way and real-time information exchange between power providers and consumers in a way of applying information technology (IT) to the existing power grid.

### DISCLOSURE OF INVENTION

### Technical Problem

Embodiments provide a method of controlling a network system for managing power through communication.

### Solution to Problem

In one embodiment, there is provided a method of controlling a network system, the method including: determining whether a communication modem of an electric product is operable by transmitting a signal between the communication modem and a component; and if the communication modem is operable for communication with the component, controlling an operation of the electric product based on power information received through the communication modem.

The details of one or more embodiments are set forth in the accompanying drawings and the description below. Other features will be apparent from the description and drawings, and from the claims.

### Advantageous Effects of Invention

According to the embodiments, electric products are controlled based on power information according to a power management program, and thus electricity charge and power consumption amount can be reduced.

In addition, if a communication modem is not operable for communication, a user is informed of the state. Therefore, the user can reinstall the communication modem or replace it with another communication modem.

### BRIEF DESCRIPTION OF DRAWINGS

FIG. 1 is a schematic view illustrating a network system of an embodiment.

FIG. 2 is a control block diagram illustrating the network system according to an embodiment.

FIG. 3 is a view illustrating an electric product provided with a communication modem according to an embodiment.

FIG. 4 is a flowchart for explaining a method of determining a communication state of a communication modem provided at an electric product according to an embodiment.

FIG. 5 is a flowchart for explaining a method of executing a power management program when a communication modem operates normally according to an embodiment.

FIG. 6 is a view illustrating an energy management system (EMS) displaying results obtained by a controlling method according to an embodiment.

FIG. 7 is a graph illustrating an electricity rate and a power consumption amount with respect to time.

### BEST MODE FOR CARRYING OUT THE INVENTION

Reference will now be made in detail to the embodiments of the present disclosure, examples of which are illustrated in the accompanying drawings.

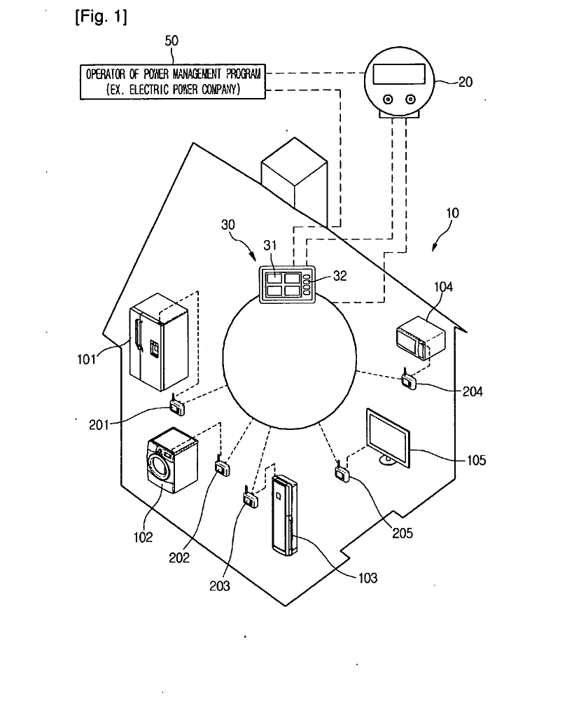

FIG. 1 is a view illustrating a network system 10 according to an embodiment.

Referring to FIG. 1, the network system 10 includes: a metering device (smart meter) 20 which can measure power supplied to a residential customer and the electricity charge of the power in real time; and an energy management system (EMS) 30 connected to the metering device (smart meter) 20 and a plurality of electric products such as home appliances for controlling the electric products.

Here, the electricity charge is measured based on an electricity rate. The electricity rate is high in a time period where power consumption increases steeply and low in a time period such as midnight where a relatively small amount of power is consumed.

The network system 10 is operated by a power management program made to efficiently mange electricity charges and power consumptions in the residential customer according to time-varying electricity rates.

For executing the power management program, the EMS 30 and the metering device (smart meter) 20 communicates with an operator 50 of the power management program, such as an electric power company.

The EMS 30 may be provided in the form of a terminal, which includes a screen 31 to display the current power consumption state and external environments (temperature, humidity) and an input unit 32 to receive user's manipulations.

The EMS 30 and the metering device (smart meter) 20 are selectively or simultaneously connected to the electric products such as a refrigerator 101, a washing or drying machine 102, an air conditioner 103, a TV 105, and a cooking device 104 through an in-house network for communication.

Communication modems 200 (201 to 205) are detachably provided to the electric products for wireless communication with the EMS 30 and the metering device (smart meter) 20.

The communication modems 200 may be coupled to the outsides of the electric products for each attachment and detachment.

The communication modems 200 are operated according to ZigBee (wireless communication method) for communications such as one-to-one, one-to-many, and many-to-many communications. However, the communication method of the communication modems 200 is not limited to ZigBee. Other wireless communication methods may be used.

Therefore, power information or operation information of the electric products provided with the communication modems 200 can be transmitted to the EMS 30 or the metering device (smart meter) 20 through the communication modems 200, and information can be transmitted in the opposite direction.

Slots or ports may be formed in the electric products for attaching and detaching the communication moderns 200.

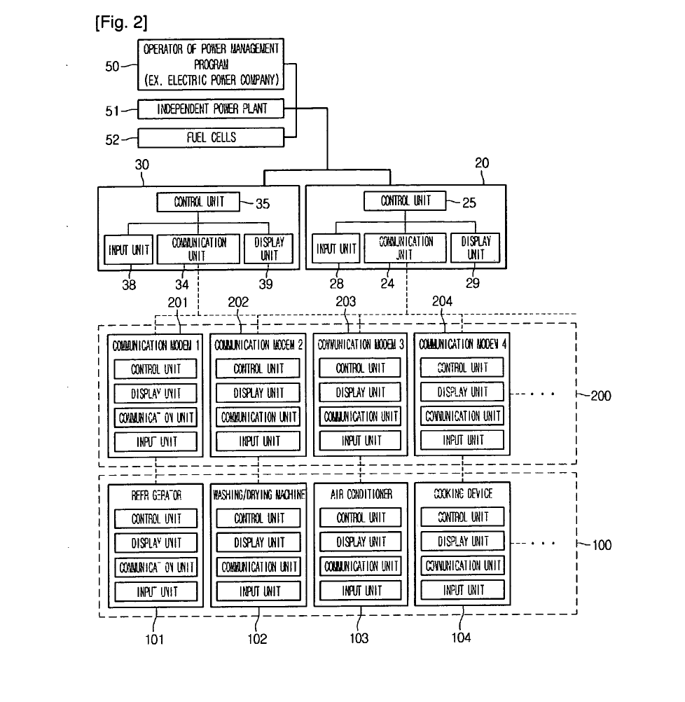

FIG. 2 is a control block diagram illustrating the network system 10 according to an embodiment.

Referring to FIG. 2, the power management program operator 50 may have a general power generation plant (e.g., thermal power, nuclear power, and water power generation plants) or a power generation plant using renewable energy sources (e.g., solar light, wind power, and geothermal power). However, the power management program operator 50 is not limited thereto.

In addition, the network system 10 may include an independent power plant 51 such as a solar power generation plant of a residential customer, and fuel cells 52 of a fuel cell vehicle or a residential customer.

Such power supply sources and the power management program operator 50 are connected to the metering device (smart meter) 20 and the EMS 30.

In addition, the metering device (smart meter) 20 and the EMS 30 can communicate with the electric products (denoted by reference numeral 100 in FIG. 2) through the communication modems 200.

The EMS 30 may include a control unit 35, an input unit 38, a communication unit 34, and a display unit 39, and the metering device (smart meter) 20 may include a control unit 25, an input unit 28, a communication unit 24, and a display unit 29.

The communication units 34 and 24 communicate with the communication modems 201 to 204 of the electric products 100 such as the refrigerator 101, the washing or drying machine 102, the air conditioner 103, and the cooking device 104 for transmitting and receiving power information and operation information.

At least one of the control units 25 and 35 of the metering device (smart meter) 20 and the EMS 30 checks information in real time, such as setting information input by a user through the input unit 28 or 38, accumulated operation and power consumption history information of the electric products 100, and external power supply information.

Such information is processed in real time to control operations of the electric products 100 and power supply to the electric products 100.

The display units 29 and 39 display power information of the power supply sources or operation and power information of the electric products 100, and communication states of the electric products 100.

The EMS 30 or the metering device (smart meter) 20 controls operations of the electric products 100. The EMS 30 or the metering device (smart meter) 20 provides an electricity charge saving mode for saving electricity charges of the electric products 100, and an energy-saving operation mode for reducing power consumption.

The electricity charge saving mode is performed based on electricity rates varying according to operation times of the electric products 100.

The EMS 30 or the metering device (smart meter) 20 controls the electric products 100 in consideration of a peak time period the electricity rate of which is higher than a reference value, or in consideration of an upper limit of power consumption or electricity charge.

The electric products 100 may be operated in the electricity charge saving mode in consideration of a peak time period or an upper limit of power consumption by joining the power management program provided by the electric power company.

If electric power is managed by joining a power management program, electricity charge may be saved, and moreover other effects may be attained such as getting a benefit of electricity charge reducing policies.

The communication modems 201 to 204 may include control units, display units, communication units, and input units. The communication modems 201 to 204 may display current communication states and receive user's inputs.

The communication modems 201 to 204 are connected to the EMS 30 or the metering device (smart meter) 20 for communication, so that the communication modems 201 to 204 can receive an instruction of the power management program from the EMS 30 or the metering device (smart meter) 20 and deliver the instruction to the electric products 100. Thus, the electric products 100 can be controlled according to the power management program.

In addition, the control units of the communication modems 200 may be configured to control the electric products 100 according to time-varying electricity rates, an upper limit of electricity charge, or an upper limit of power consumption. That is, the electric products 100 may operate in power-saving operation mode such as electricity charge saving mode or energy-saving operation mode under self control conditions using the communication modems 200.

Each of the electric products 100 may include a display unit and a control unit. The display unit may display an operation state of the electric product 100 and a communication state of the communication modem 200 of the electric product 100.

Therefore, a user can easily check communication states of the communication modems 200 through the display unit of the EMS 30, the metering device (smart meter) 20, the communication modems 200, or the electric products 100, and if any one of the communication modems 200 is abnormal, the user can reinstall the communication modem 200 on the electric product 100 or replace the communication modem 200.

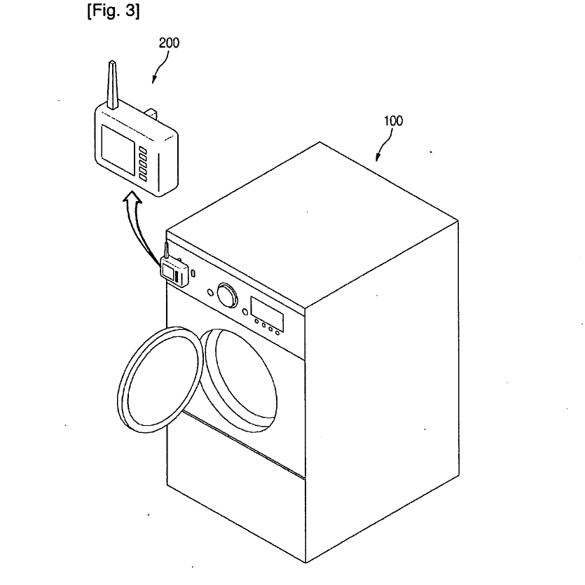

FIG. 3 is a view illustrating an electric product 100 provided with a communication modem 200 according to an embodiment.

Referring to FIG. 3, the communication modem 200 is not built in the electric product 100 but fixed to a port or slot of the electric product 100.

Therefore, a user can easily attach the communication modem 200 to the electric product 100 and detach the communication modem 200 from the electric product 100. Therefore, for example, when the user bought a new electric product 100, the user can easily connect the new electric product 100 to the power management network for executing the power management program, without having to call a service engineer.

Alternatively, the electric product 100 may be fixed to the inside of the electric product 100.

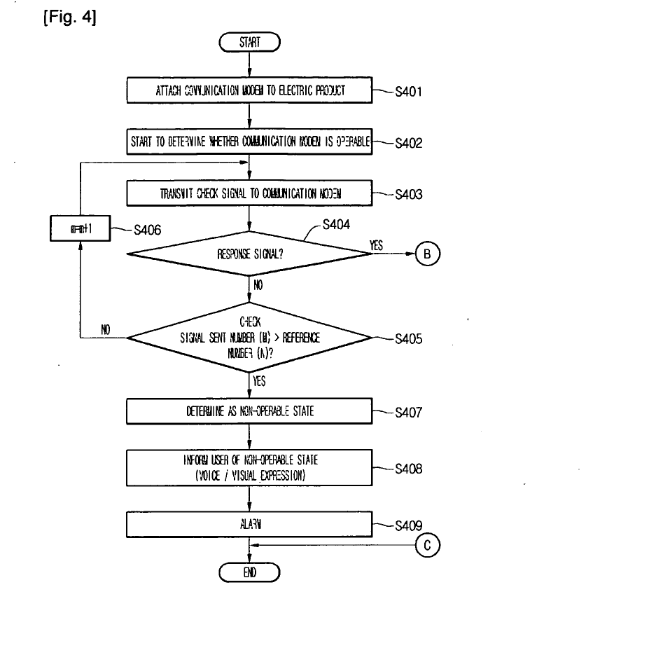

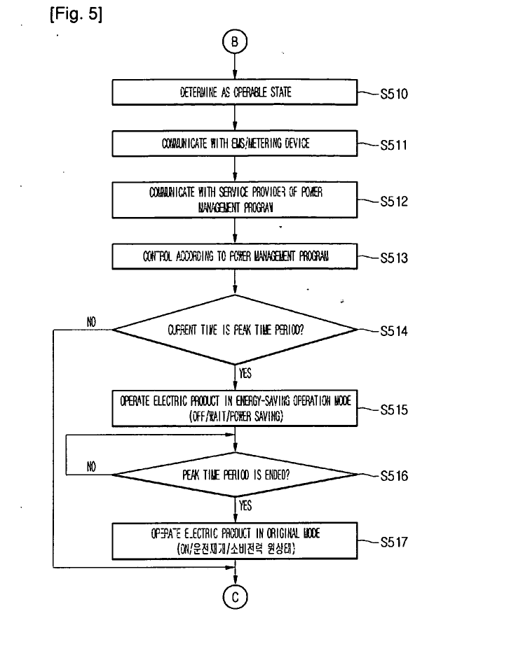

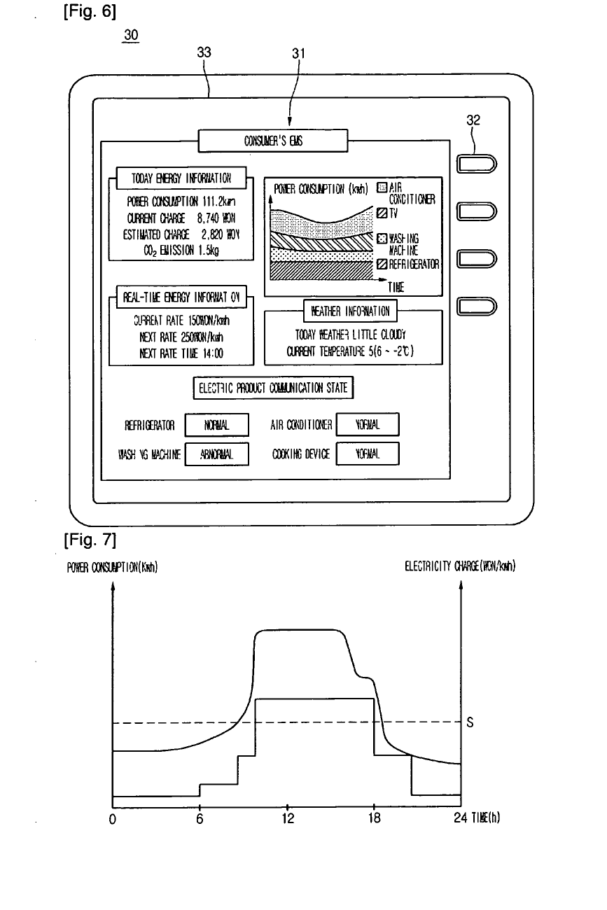

FIG. 4 is a flowchart for explaining a method of determining a communication state of a communication modem provided at an electric product according to an embodiment; FIG. 5 is a flowchart for explaining a method of executing a power management program when the communication modem operates normally according to an embodiment; and FIG. 6 is a view illustrating an EMS displaying results obtained by a controlling method according to an embodiment.

First, referring to FIG. 4, a detachable communication modem is attached to an electric product (S401). Then, it is started to determine whether the communication modem is properly attached or the communication modem is operable for communication (S402).

An EMS, a metering device (smart meter), or the electric product sends a check signal to the communication modem (S403). Here, the EMS, the metering device (smart meter), and the electric product are components for communicating with the communication modem.

Next, it is determined whether the communication modem outputs a response signal (S404). If it is determined that there is no response signal, it is determined whether the sent number (m) of the check signal is greater than a predetermined reference number (n) (S405).

Since it is not reliable to determine the communication state of the communication modem after sending a check signal once, the check signal is sent a plurality of times to reliably determine the communication state of the communication modem. If the communication modem does not response although the check signal is sent a plurality of times, it is determined that the communication modem is not operable for communication, and follow-up measures are taken.

In the state where there is no response signal, if the sent number (m) of the check signal is not greater than the reference number (n), the method goes to operation S406 and operation 403 to send the check signal again.

On the other hand, in the state-where there is no response signal, if it is determined that the sent number (m) of the check signal is greater than the reference number (n), it is determined that the communication modem is not operable for communication (S407).

To rapidly inform a user of the non-operable state of the communication modem of the electric product, at least one of the EMS, the metering device (smart meter), and the electric product outputs a notification expression (S408).

The non-operable state may be reported by a sound expression such as an alarming sound as well as a visual expression.

If the non-operable state continues, an alarming message may be displayed to warn the user of the possibility of regarding it as withdrawal from a power management program provided by an electric power company and the resulting disadvantages (S409).

In response to the alarming message, the user may reinstall the communication modem properly or replace the communication modem with a non-defective communication modem.

If there is a response signal from the communication modem, it is determined that the communication modem is properly attached to the electric product and operable for communication as shown in FIG. 5 (S501).

The communication modem may communicate with the EMS or the metering device (smart meter) (S511) and a service provider of the power management program (S512).

Then, the electric product joins the power management program, and the electric product is controlled according to the power management program (S513).

According to the power management program, in a peak time period (refer to FIG. 7), power consumption of the electric product may be reduced or the electric product may be stopped to reduce the electricity cost, or if the electric product consumes more power than a preset upper limit of power consumption, the electric product may be stopped or the user may informed of it.

After the electric product starts to be controlled, it is determined whether the current time is in a peak time period (S514). If the current time is in a peak time period, the electric product is operated in an energy-saving operation mode (S515).

The energy-saving operation mode may include turning-off the electric product, making the electric product wait in an off-state for a predetermined time (e.g., for the peak time period), and operating the electric product with less power.

Then, it is determined whether the peak time period is ended (S516). If the peak time period is ended, the electric product is operated in an originally set mode (for example, turning on, operation resuming, or operation with normal power) (S517).

As well as the above-described operations of the electric product being controlled by the EMS or the metering device (smart meter) according to the power management program, such operations of the electric product may be controlled by the communication modem if the communication modem has such power control functions (a power consumption reducing function in a peak time period and a power control function according to a set upper limit).

By the above-described controlling methods, as shown in FIG. 6, the EMS (30) may display communication state and real-time energy information of electric products, and real-time power consumption amounts of the electric products. Then, a user may easily recognize such information.

Such information may also be displayed on the metering device (smart meter).

FIG. 7 is a graph illustrating an electricity rate and a power consumption amount with respect to time.

As shown in FIG. 7, generally, when power consumption is highest, the electricity rate is highest. This period is called a peak time period.

If power is consumed in such a peak time period, the electricity charge is high as compared with the case where power is consumed in a non-peak time period. The power management program prevents or reduces power consumption in a peak time period so that electricity charge can be reduced.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1. A method of controlling an electric product, the method comprising:
determining whether a communication device is operable by transmitting a signal between the communication device and a component; and
if the communication device is operable for communication with the component, controlling an operation of the electric product based on power information received through the communication device.

2. The method according to claim 1, wherein the component is one of an energy management system (EMS) to check a state of the electric product or control the operation of the electric product, a metering device to measure a power consumption amount of the electric product, and the electric product.

3. The method according to claim 1, wherein the determining comprises:
transmitting a check signal to the communication device by the component; and
determining whether a response signal is received from the communication device by the component.

4. The method according to claim 3, wherein if the component receives the response signal from the communication device, the method further comprises communicating with the communication device by the component.

5. The method according to claim 3, wherein if the component does not receive the response signal from the communication device, the method further comprises:
determining whether the check signal is sent more than a predetermined number of times; and
if it is determined that the check signal is sent more than the predetermined number of times times, determining that the communication device is not operable for communication.

6. The method according to claim 5, wherein if the communication device is not operable for communication, the method further comprises displaying the non-operable state information on the component.

7. The method according to claim 1, wherein the communication device sending an operation instruction to the electric product based on the power information by the communication device.

8. The method according to claim 1, further comprises operating the electric product in a mode for reducing a power consumption amount or an electricity charge based on the power information.

9. The method according to claim 1, further comprises operating the electric product in a mode not to exceed an upper limit of electricity charge based on the power information.

10. An electric product for a network system comprising:
a communication device in which power information is communicated; and
a controller that controls an operation of the electric product based on the power information received through the communication device when the communication device is operable; and
a display to display information.

11. The electric product according to claim 10, wherein the display displays at least one of power information of a power source, an operation information of the electric product, power information related to the electric product, and a communication state of the electric product.

12. The electric product according to claim 10, wherein the communication device is detachably attached to the electric product.

13. The electric product according to claim 10, wherein the network system further comprises:
a component that determines whether communication is operable by transmitting a signal between the component and the communication device.

14. The electric product according to claim 13, wherein if the component receives a response signal from the communication device, the component determines that the communication device is operable.

15. The electric product according to claim 14, wherein if the component does not receive the response signal from the communication device, the component determines whether the check signal is sent more than a predetermined number of times; and
if it is determined that the check signal is sent more than the predetermined number of times, the component determines that the communication device is not operable for communication.

16. The electric product according to claim 13, wherein if the communication device is not operable for communication, the component displays the non-operable state information.

17. The electric product according to claim 13, wherein the component is one of an energy management system (EMS) to check a state of the electric product or control the operation of the electric product, a metering device to measure a power consumption amount of the electric product, and the electric product.

18. The electric product according to claim 10, wherein the communication device sends an operation instruction to the electric product based on the power information.

19. The electric product according to claim 18, wherein the electric product operates in a mode for reducing a power consumption amount or an electricity charge based on the power information.

20. The electric product according to claim 18, wherein the electric product operates in a mode not to exceed an upper limit of electricity charge based on the power information.
